(19) United States
(12) Patent Application Publication
(10) Pub. No.: US 2022/0099286 A1
(43) Pub. Date: Mar. 31, 2022

(54) HEAT SINKING LIGHT PIPE

(71) Applicant: Panasonic Automotive System Company of America, Division of Panasonic Corporation of North America, Peachtree City, GA (US)

(72) Inventor: NICHOLAS BRIAN HANSEN, FAYETTEVILLE, GA (US)

(73) Assignee: Panasonic Automotive System Company of America, Division of Panasonic Corporation of North America

(21) Appl. No.: 17/489,239

(22) Filed: Sep. 29, 2021

Related U.S. Application Data
(60) Provisional application No. 63/085,272, filed on Sep. 30, 2020.

(51) Int. Cl. F21V 29/70; F21V 29/503; F21V 8/00

(52) U.S. Cl. CPC F21V 29/70; F21Y 2115/10; G02B 6/0008; F21V 29/503

(57) ABSTRACT

A heat sink arrangement includes a thermally conductive light pipe engaging a light emitting device and including an input and an output. The light pipe receives light from the light emitting device at the input, emits the received light at the output, and draws heat out of the light emitting device.

### CROSS-REFERENCED TO RELATED APPLICATIONS

This application claims benefit of U.S. Provisional Application No. 63/085,272, filed on Sep. 30, 2020, the disclosure of which is hereby incorporated by reference in its entirety for all purposes.

### BACKGROUND OF THE INVENTION

### 1. Field of the Invention

The present invention relates to a heat sink, and, more particularly, to a heat sink for dissipating heat from a component in a motor vehicle.

### 2. Description of the Related Art

Often when an LED is utilized in an electronics application, the light from the LED needs to be redirected or manipulated in order to achieve the desired optical results. Light pipes are often implemented to accomplish the required redirection or manipulation. A light pipe is simply a translucent structure that, through the process of internal reflection, changes the path of photons. Currently, light pipes are primarily composed of polymers that are thermally insulating and, therefore, actually hinder the LED's ability to dissipate heat.

One of the major difficulties faced in electronics applications is the handling of heat. The thermal stability of electronics applications is often improved through the use of heat sinks. Heat sinks are known to physically engage and carry heat away from electronic components that otherwise may be damaged by the heat. Heat sinks improve the thermal stability of electronics by effectively redirecting the thermal energy away from the sensitive components in such a way that the thermal energy can either be removed via convection or conduction or by simply increasing the thermal mass to increase the time it takes the electronics to heat up to a critical temperature. Currently, heat sinks are primarily composed of opaque metals that make them ineffective as light pipes.

The heat sink typically is made of aluminum and has a base with a surface that contacts the electronic component. The heat sink also typically has a series of fins extending from the base in a direction away from the electronic component. The fins provide a large surface area within a limited three-dimensional space to thereby increase the rate of convection of heat from the heat sink to the air. Traditionally, heat sinks are either cast or extruded and require expensive tooling to produce.

### SUMMARY OF THE INVENTION

The invention may provide a device that functions as both a heat sink and a light pipe. Properly shaped, optically transparent ceramics, such as spinel, may be used to provide both the function of a light pipe and the function of a heat sink simultaneously. By exploiting the proximity of the light pipe to an LED, one of the major sources of heat in many electronics applications, an optically transparent ceramic light pipe may greatly increase the thermal stability of the associated electronics by effectively extracting the heat from the LED. Spinel has a thermal conductivity greater than 10 W/m*K as compared to a thermal conductivity of less than 1 W/m*K for many transparent polymers.

The invention comprises, in one form thereof, a heat sink arrangement including a thermally conductive light pipe engaging a light emitting device and including an input and an output. The light pipe receives light from the light emitting device at the input, emits the received light at the output, and draws heat out of the light emitting device.

The invention comprises, in another form thereof, a method of removing heat from a light emitting device, including emitting light from a light emitting device. The light emitting device is engaged by a thermally conductive light pipe. The light emitted from the light emitting device is received at an input of the light pipe. The received light is emitted at an output of the light pipe. Heat is drawn out of the light emitting device and into the light pipe.

The invention comprises, in yet another form thereof, a heat sink arrangement including a thermally conductive light pipe positioned in association with a light emitting device. The light pipe receives light from the light emitting device, emits the received light at a location that is at a distance from the light emitting device, and draws heat out of the light emitting device.

### BRIEF DESCRIPTION OF THE DRAWINGS

The above-mentioned and other features and objects of this invention, and the manner of attaining them, will become more apparent and the invention itself will be better understood by reference to the following description of embodiments of the invention taken in conjunction with the accompanying drawings, wherein:

FIG. 1 is a schematic diagram of one embodiment of a heat sinking light pipe arrangement of the present invention.

FIG. 2 is a flow chart of one embodiment of a method of the present invention for removing heat from a light emitting device.

### DETAILED DESCRIPTION

The embodiments hereinafter disclosed are not intended to be exhaustive or limit the invention to the precise forms disclosed in the following description. Rather the embodiments are chosen and described so that others skilled in the art may utilize its teachings.

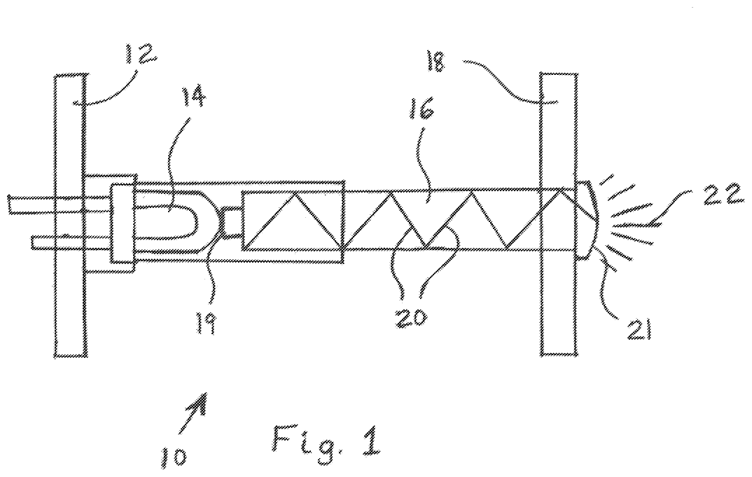

FIG. 1 illustrates one embodiment of a heat sinking light pipe arrangement 10 of the present invention, including a circuit board 12, a light emitting diode (LED) 14, a light pipe 16, and a face plate 18, which may be facing a driver of a motor vehicle, for example. LED 14 is attached to and electrically connected to circuit board 12, and receives electric power from circuit board 12.

Light pipe 16 engages LED 14 and is positioned to receive light emitted by LED 14. Light pipe 16 may be retained by face plate 18. Light pipe 16 may be formed of an optically transparent ceramic material, such as spinel. The material that light pipe 16 is made of may have a thermal conductivity of greater than 2 W/m*K, and may be greater than 10 W/m*K.

During the operation, LED 14 draws electrical current from circuit board 12 and produces visible light. As LED 14 draws current, LED 14 also heats up. Light pipe 16 touches and engages LED 14, and light pipe 16 draws and absorbs heat away from LED 14. An input 19 of light pipe 16 receives light produced by LED 14 and the light propagates within light pipe 16, as schematically indicated zig-zagging line 20 until the light exits an output 21 of light pipe 16, as indicated at 22. A human user may be positioned such that he sees light 22 emitted by light pipe 16.

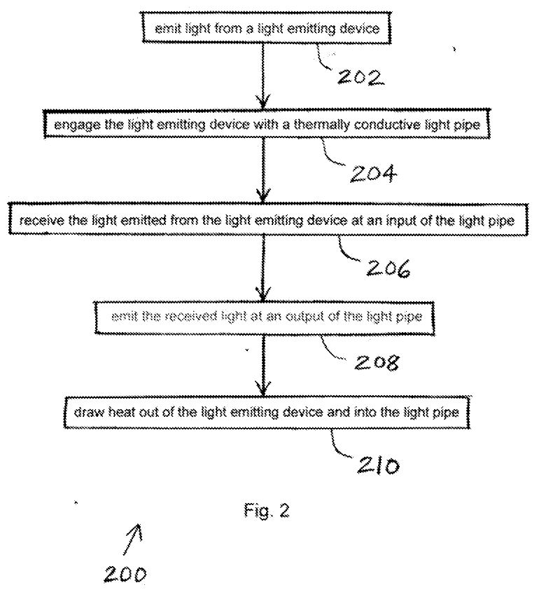

FIG. 2 illustrates one embodiment of a method 200 of the present invention for removing heat from a light emitting device. In a first step 202, light is emitted from a light emitting device. For example, light may be emitted from light emitting diode (LED) 14.

Next, in step 204, the light emitting device is engaged by a thermally conductive light pipe. For example, light emitting diode (LED) 14 may touch or be in physical contact with light pipe 16.

In a next step 206, the light emitted from the light emitting device is received at an input of the light pipe. For example, an input 19 of light pipe 16 receives light produced by LED 14.

In step 208, the received light is emitted at an output of the light pipe. For example, the light received by light pipe 16 may be emitted at an output 21 of light pipe 16.

In a final step 210, heat is drawn out of the light emitting device and into the light pipe. For example, because light pipe 16 touches and engages LED 14, light pipe 16 draws and absorbs heat away from LED 14 and into light pipe 16.

While this invention has been described as having an exemplary design, the present invention may be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains.

What is claimed is:

1. A heat sink arrangement, comprising:
a light emitting device; and
a thermally conductive light pipe engaging the light emitting device and including an input and an output, the light pipe being configured to:
receive light from the light emitting device at the input;
emit the received light at the output; and
draw heat out of the light emitting device.

2. The heat sink arrangement of claim 1 wherein the light pipe is electrically insulating.

3. The heat sink arrangement of claim 1 wherein the input of the light pipe engages the light emitting device.

4. The heat sink arrangement of claim 1 wherein the light pipe has a thermal conductivity of greater than 2 W/m*K.

5. The heat sink arrangement of claim 1 wherein the light pipe has a thermal conductivity of greater than 8 W/m*K.

6. The heat sink arrangement of claim 1 wherein the light pipe is formed of a ceramic material.

7. The heat sink arrangement of claim 1 wherein the light pipe is formed of spinel.

8. A method of removing heat from a light emitting device, the method comprising:
emitting light from a light emitting device;
engaging the light emitting device with a thermally conductive light pipe:
receiving the light emitted from the light emitting device at an input of the light pipe;
emitting the received light at an output of the light pipe; and
drawing heat out of the light emitting device and into the light pipe.

9. The method of claim 8 wherein the light pipe is electrically insulating.

10. The method of claim 8 wherein the input of the light pipe engages the light emitting device.

11. The method of claim 8 wherein the light pipe has a thermal conductivity of greater than 5 W/m*K.

12. The method of claim 8 wherein the light pipe is formed of a ceramic material or spinel.

13. A heat sink arrangement, comprising:
a light emitting device; and
a thermally conductive light pipe positioned in association with the light emitting device, the light pipe being configured to:
receive light from the light emitting device;
emit the received light at a location that is at a distance from the light emitting device; and
draw heat out of the light emitting device.

14. The heat sink arrangement of claim 15 wherein the light pipe is electrically insulating.

15. The heat sink arrangement of claim 15 wherein the light pipe engages the light emitting device.

16. The heat sink arrangement of claim 15 wherein the light pipe has a thermal conductivity of greater than 2 W/m*K.

17. The heat sink arrangement of claim 15 wherein the light pipe has a thermal conductivity of greater than 8 W/m*K.

18. The heat sink arrangement of claim 15 wherein the light pipe is formed of a ceramic material.

19. The heat sink arrangement of claim 15 wherein the light pipe is formed of spinel.

20. The heat sink arrangement of claim 15 wherein the light pipe is configured to emit the received light at a location that is approximately between 3 millimeters and 300 millimeters from the light emitting device.
